(19) United States
(12) Patent Application Publication
(10) Pub. No.: US 2008/0065327 A1
(43) Pub. Date: Mar. 13, 2008

(54) Navigation device for use in automotive vehicle

(75) Inventor: Eiji Sobue, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/898,229

(22) Filed: Sep. 11, 2007

(30) Foreign Application Priority Data
Sep. 12, 2006 (JP) 2006-246754

(51) Int. Cl. G01C 21/32

(52) U.S. Cl. 701/211; 340/441

(57) ABSTRACT

In a navigation device for use in an automotive vehicle, whether a present position of the vehicle is on an old road included in stored map data or on a new road not included in the stored map data is detected. When the vehicle enters onto the new road from the old road, whether a driving speed of the vehicle changed or not is checked. If the driving speed did not change, it is determined that the new road is actually a new road, and a driven locus on the new road is memorized. The driven locus is registered as a new road in the stored map data. In this manner, the new road is quickly registered after it is used only one time, while avoiding registration of a parking space or the like in error. In registering a new road, a driver's intention may be asked to further reduce possibility of erroneous registration.

### CROSS-REFERENCE TO RELATED APPLICATION

This application is based upon and claims benefit of priority of Japanese Patent Application No. 2006-246754 filed on Sep. 12, 2006, the content of which is incorporated herein by reference.

### BACKGROUND OF THE INVENTION

1. Field of the Invention

The present invention relates to a navigation device for use in an automotive vehicle, the navigation device including a function to register a new road that is not included in a stored map data.

2. Description of Related Art

In a navigation device mounted on an automotive vehicle, a present position of the vehicle is detected, and a map around the present position is read out from map data stored in a memory and displayed on a display panel. The present position and a direction of driving are shown on the display map with a pointer mark. When a route guidance is required by a driver, a driving route to a destination is displayed on the map, and the driver is guided by voice and other instructions displayed on the display panel.

When the vehicle is driven on a new road (such as a newly constructed road) which is not included in the stored map data, the new road is not shown in the display panel. Naturally, a driving route calculated by the navigation device does not include the new road. Accordingly, if the driver follows the calculated driving route, he/she cannot drive on the new road even if the new road provides a shorter route to the destination. To cope with this problem, JP-A-2000-88595 proposes to register a driven locus of the vehicle as a new road after the vehicle is driven on the new road several times.

The proposed method for register a new road is inconvenient for a driver because the new road is registered only after the vehicle is driven several times on the new road. However, if the locus once driven is immediately registered as a new road, there would occur erroneous registration, because the driven locus may not be a new road but it may be a parking space or a private driveway.

### SUMMARY OF THE INVENTION

The present invention has been made in view of the above-mentioned problem, and an object of the present invention is to provide an improved car navigation device that includes a function for registering a new road immediately after it is used while avoiding erroneous registration.

The navigation device mounted on an automotive vehicle includes a display panel for displaying a map readout from stored map data. A present position of the vehicle is also displayed on the display panel, being overlapped on the map. Whether the present position of the vehicle is on an old road which is included in the stored map data or on a new road which is not included in the stored map data is determined. When the vehicle leaves the old road and enters onto the new road, whether a driving speed of the vehicle is changed or not is checked. If there is a speed change in excess of certain amount, it is determined that the new road is not actually a new road but it is a parking space or a small private driveway. On the other hand, if there is no speed change, it is determined that the new road is actually a new road.

When it is determined that the vehicle drives actually on a new road, a driven locus of the vehicle is memorized and registered as a new road in the stored map data. In this manner, the new road, which is not included in the stored map data (which may be newly built or opened), is registered immediately after the new road is used only once. At the same time, registration of a parking space or a small private driveway is avoided to the utmost.

It is also possible to ask a driver whether he/she has recognized a road, on which the vehicle has been driven, as an actually new road or not when the vehicle returns to the old road. Only when the driver's reply is affirmative, the driven locus is registered as a new road in the stored map data. In this manner, erroneous registration can be further reduced.

Alternatively, driver's intention as to whether he/she wants to register a new road on which he/she is going to drive may be asked, when a driving route is searched in the navigation device. If the driver wishes to register a new road connected to one of the old roads included in the stored map data, he/she inputs a starting point and an ending point of the new road or a line connecting both points. A driven locus on the new road is memorized, and the driven locus is registered as a new road in the stored map data when the vehicle returns to the old road. In this manner, a new road is surely registered based on driver's intention.

According to the present invention, a new road which is not included in the stored map data is registered when the new road is used only one time, while avoiding erroneous registration. Other objects and features of the present invention will become more readily apparent from a better understanding of the preferred embodiments described below with reference to the following drawings.

### BRIEF DESCRIPTION OF THE DRAWINGS

FIG. 1 is a block diagram showing an entire structure of a navigation device for use in an automotive vehicle;

FIG. 2 is a flowchart showing a process for registering a new road in stored map data, as a first embodiment of the present invention;

FIG. 3 is a flowchart showing a process for obtaining vehicle speed and its present position;

FIG. 4 is a flowchart showing a process for displaying a map on a display panel;

FIGS. 5 and 6 are a flowchart showing a process for selecting an operating mode in the navigation device and for registering a new road in stored map data; and

FIG. 7 is a schematic view showing a hypothetical new road displayed on a road map.

### DETAILED DESCRIPTION OF THE PREFERRED EMBODIMENTS

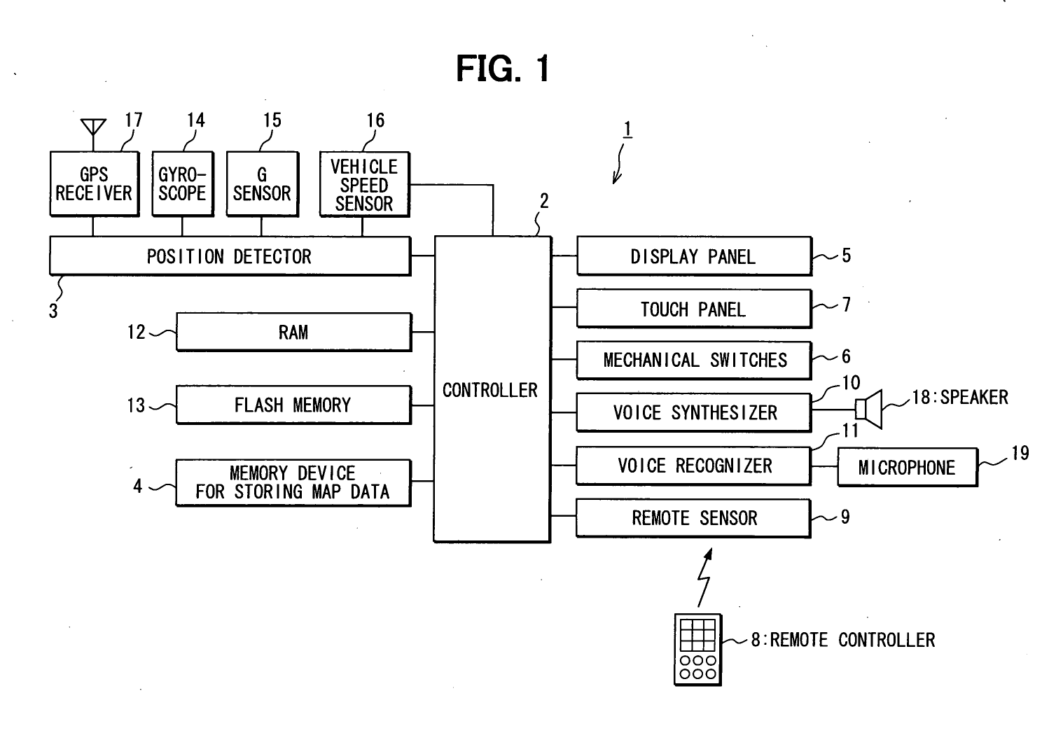

A first embodiment of the present invention will be described with reference to FIGS. 1-4. First, referring to FIG. 1, an entire structure of a navigation device 1 mounted on an automotive vehicle will be described. The navigation device 1 includes: a controller 2; a position detector 3 for detecting a present position of the vehicle; a memory device for storing map data 4; a display panel 5; a group of mechanical switches 6; a touch panel 7 for inputting commands or data; a remote controller 8; a remote sensor 9 for receiving signals from the remote controller 8; a voice synthesizer 10; a voice recognizer 11; a RAM 12; and a flash memory 13.

The controller 2 is composed of a microcomputer, a CPU, memory devices such as ROM and RAM, I/O, a bus for connecting components, and other components. The controller 2 controls an entire operation of the navigation device 1. A program for operating the navigation device 1 is stored in the ROM, and temporary operating data, map data read out from the memory device 4 and other data are temporarily stored in the RAM.

A gyroscope 14 for detecting a pitching angle of the vehicle, a G-sensor 15 for detecting a rolling angle of the vehicle, a speed sensor 16 for detecting the vehicle speed, and a GPS (Global Positioning System) receiver 17 are connected to the position detector 3. Since these detectors 14-17 include respective detecting errors, outputs of these detectors are used in combination to minimize a final error in detection. The position detector 3 calculates a driven distance by integrating the vehicle speed detected by the speed sensor 16, and a present position of the vehicle is calculated based on the driven distance in combination with outputs of other detectors 14, 15 and 17. The vehicle speed is also fed to the controller 2.

The memory device 4 for storing the map data includes memory media such a DVD-ROM disc and a device for reading out the stored map data. The map data read out from the memory device 4 are inputted to the controller 2. The memory device 4 also stores the following data in addition to the map data: data for giving route guidance by voice; data for searching positions of facilities on a map from names of the facilities; data for searching facilities according to classification of the facilities; and data for displaying facilities with logo-marks. In the map data stored in the memory device 4, all roads are divided into nodes such as intersections, and spans among nodes are defined as links. The road map is constituted by connecting those links.

The display panel is composed of a color liquid crystal panel or the like. Data and commands are inputted from the mechanical switches 6, the touch panel 7 and the remote controller 8. The mechanical switches 6 are disposed on a frame of the display panel 5, and the touch panel 7 is formed on a display screen of the display panel as a transparent section. Voices synthesized in the voice synthesizer 10 are outputted from a speaker 18. Voices inputted from a microphone 19 are fed to the voice recognizer 11, and the output of the voice recognizer 11 is fed to the controller 2.

The present position of the vehicle detected by the position detector 3 is fed to the controller 2 and displayed on the map shown on the display panel 5 in a form of a pointer having an arrow showing a driving direction. A scale of the map shown on the display panel 5 can be changed by touching the touch panel 7 on the display panel 5. The controller 2 includes various functions such as those for searching a driving route to a destination inputted by a driver, for outputting voices from the speaker 18 for guiding the driver along the driving route, and for displaying an intersection in an enlarged scale. As a method for searching a driving route from a departing point to a destination, the Dykestra method or other methods are used.

The RAM 12 and the flash memory 13 are memory devices disposed outside of the controller 2. The RAM 12 has a temporary memory region for temporarily memorizing various data, a locus memory region for memorizing changes of the present position of the vehicle (a driven locus), a speed memory region for memorizing the vehicle speed, a new road classification memory region for memorizing a classification of a new road. Each of these memory regions is capable of storing a predetermined amount of data, and old data exceeding a capacity of the memory region are eliminated according to addition of new data. The flash memory 13 memorizes new roads which are not included in the stored map data when the vehicle is driven on the new roads. The data memorized in the flash memory 13 are used as part of the map data stored in the memory device 4. In other words, the road stored in the flash memory 13 is displayed on the display panel 5 together with the map data stored in the memory device 4.

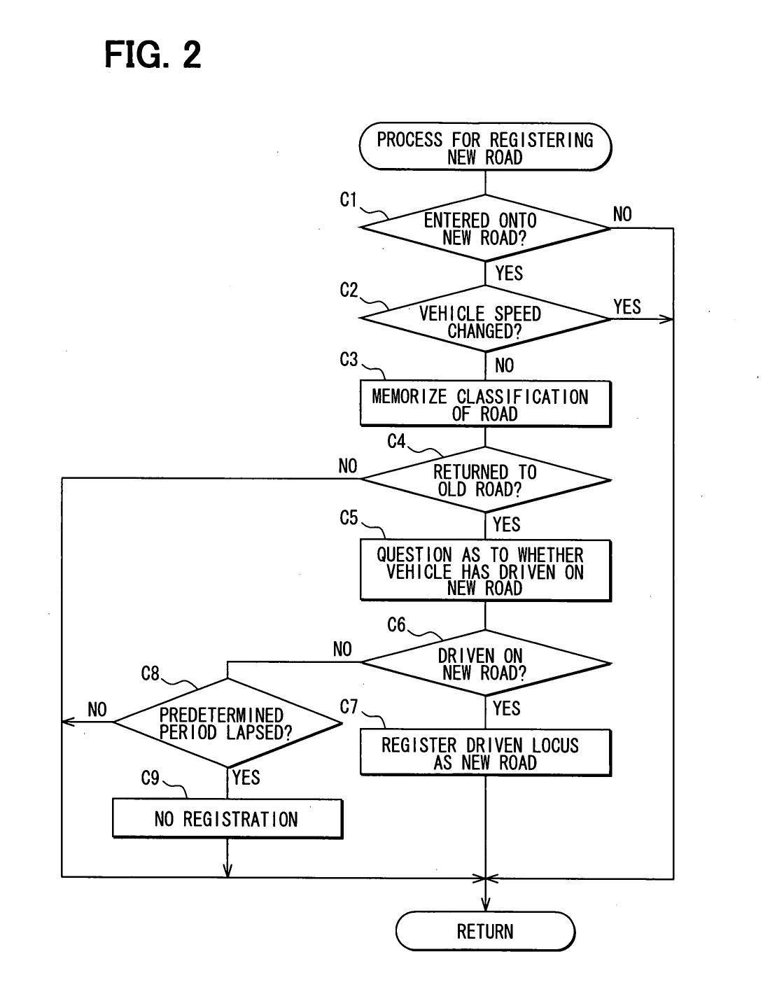

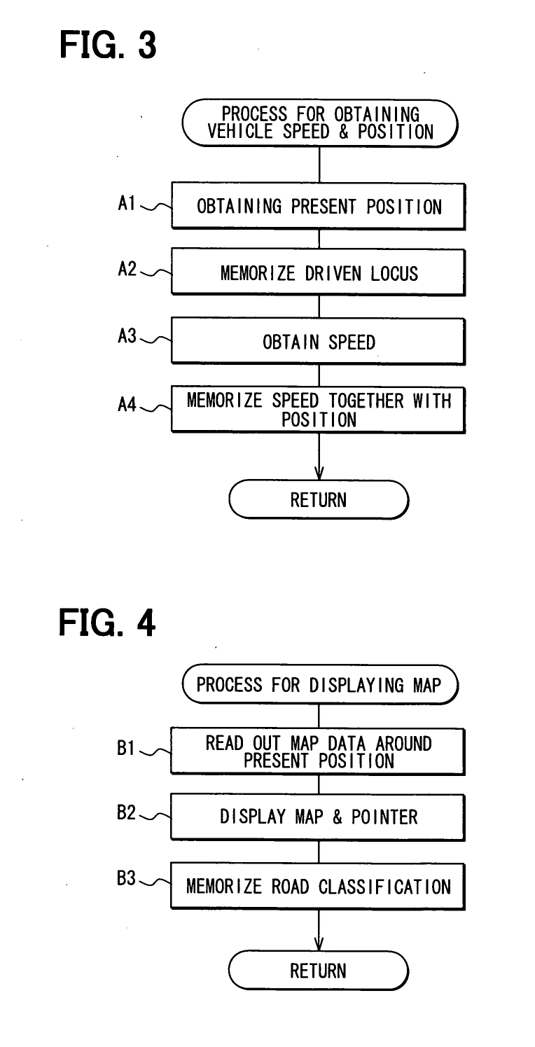

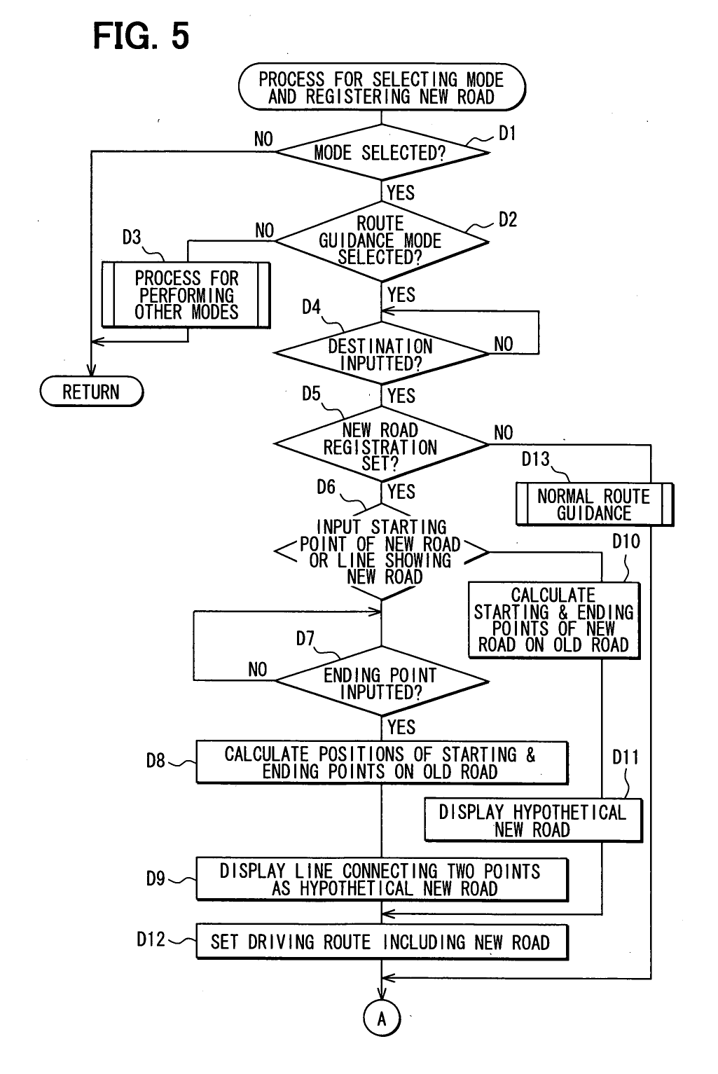

Now, a process for registering a road which is not included in the stored map data (referred to as a new road) will be explained with reference to FIGS. 2-4. In the following explanation, the map data memorized in the flash memory 13 are referred to as map data together with the map data stored in the memory device 4. Upon turning on the navigation device 1, a process for obtaining the vehicle speed and the position (shown in FIG. 3) and a process for displaying a map on the display panel 5 (shown in FIG. 4) are started and repeated thereafter at a predetermined interval.

As shown in FIG. 3, at step A1, the present position of the vehicle is obtained from the position detector 3 in a form of a latitude and a longitude, for example. At step A2, changes in the present positions, i.e., a driven locus, are memorized in the locus memory region in the RAM 12. The vehicle speed is obtained from the speed sensor 16 at step A3, and memorized in the speed memory region in the RAM 12 in relation to the present vehicle speed at step A4.

As shown in FIG. 4, at step B1, the map data stored in the memory device 4 and the flash memory 13 are read out. At step B2, a map around the present position of the vehicle is displayed on the display panel 5, and a pointer showing the present position of the vehicle and the present driving direction is shown in a manner overlapped with the map. At step B3, a classification of the road on which the vehicle is now driving (e.g., a toll road, an expressway or an ordinary road) is read out from the stored map data and memorized in the temporary memory region of the RAM 12.

When the vehicle commences driving, the process for registering a new road (shown in FIG. 2) starts. In a period, in which the process shown in FIG. 2 is being performed, the processes shown in FIGS. 3 and 4 are performed at a predetermined interval. At step C1, whether the present position of the vehicle is on a road included in the stored map data (referred to as an old road) or on a new road which is not included in the stored map data (referred to as a new road). In other words, it is determined whether the vehicle entered onto a new road or not. If the vehicle is on the old road, the process proceeds directly to RETURN to terminate the process. If the vehicle enters onto a new road, the process proceeds to step C2. For example, if the vehicle enters onto a newly built expressway extended from an endpoint of the old expressway, it is determined that the vehicle left the old road and entered onto a new road because the new road is not included in the stored map data.

At step C2, whether the vehicle speed changed at a time when the vehicle entered onto the new road is checked. In determining the speed change, the vehicle speeds at several points before and after the time when the vehicle entered onto the new road are read out from the vehicle speeds stored in the RAM 12. It is determined that there is a speed change if there is a difference larger than a predetermined value between the vehicle speeds before and after the time when the vehicle entered on to the new road. It is also possible to determine whether there is a speed change or not by comparing a speed at a position immediately before the time when the vehicle entered onto the new road with the speed at a position immediately after that time.

If there is no speed change, the process proceeds to the following steps commencing with step C3 for registering a driven locus as a new road. If there is a speed change, the process directly proceeds to RETURN to terminate the process. For example, if a new expressway is extended from an old expressway, the process enters steps for registering the new road because there is no speed change. If a normal road is newly connected to an old road and the vehicle enters onto the new road without stopping or changing its speed, the process enters steps for registering the new road. On the other hand, if the vehicle stops at a traffic signal when it enters onto a newly built road, the process directly proceeds to RETURN.

At step C3, the classification of the old road stored in the temporary memory region of the RAM 12 is transferred to the region for memorizing a new road classification in the RAM 12. At step C4, whether the vehicle returned to the old road included in the stored map data from the new road is determined. If the vehicle returned to the old road, the process proceeds to step C5, where a question, “Is the road you have driven a newly built road?” is asked the driver from the speaker 18. If the driver answers “YES” at step C6, the process proceeds to step C7, where a driven locus on the new road from a point leaving the old road to a point returning to the old road is registered in the flash memory 13 together with the road classification stored in the RAM 12. Then, the process comes to RETURN. If the driver does not answer for a predetermined period of time (step C8), the process proceeds to step C9, where no registration is made. It is possible to register the driven locus as a new road without asking the driver that question, even though there is a certain possibility of erroneous registration. The new road registered in the flash memory 13 is displayed on the display panel together with the old roads stored in the map data.

As described above, the new road is registered after the vehicle drove thereon only one time. A new road onto which the vehicle enters without changing its driving speed is registered. On the other hand, a new road onto which the vehicle enters with a change of its driving speed is not registered. It is quite usual that the driving speed is reduced when the vehicle enters into a parking space or a small private driveway. Therefore, registration of a parking space or a small private driveway which should not be registered as a newly built road is avoided. Further, erroneous registration is surely avoided by asking the driver whether the driven road is a newly built road or not.

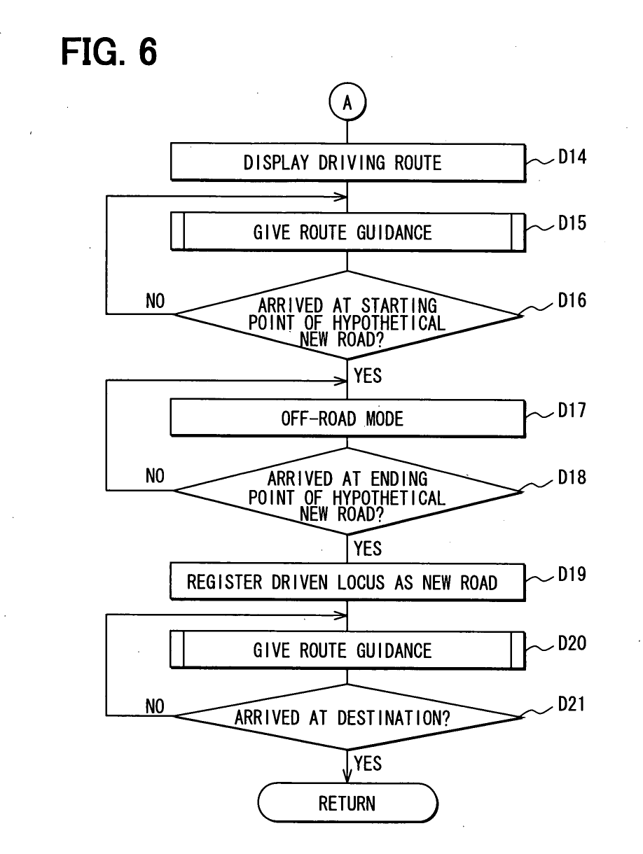

A second embodiment of the present invention will be described with reference to FIGS. 5-7. A unique feature of this embodiment resides in that a driver selects a mode to register a new road before driving on the new road. A process for selecting operating modes of the navigation device and for registering a new road is shown in FIGS. 5 and 6. A bottom end (marked with A in circle) of the process shown in FIG. 5 continues to a top portion (marked with A in circle) of the process shown in FIG. 6.

The process shown in FIGS. 5, 6, the processes shown in FIG. 3 and the process shown in FIG. 4 are repeatedly performed at respective intervals. Upon starting the process for selecting modes and for registering a new road, whether one of operating modes of the navigation device is selected or not is determined at step D1. If no mode is selected, the process comes to the end (RETURN). If one of the modes is selected, the process proceeds to step D2, where whether a route guidance mode is selected is determined. If other modes than the route guidance mode are selected, the process proceeds to step D3, where operation is carried out according to the selected mode. If the route guidance mode is selected, the process proceeds to step D4, where whether a destination is inputted or not is checked.

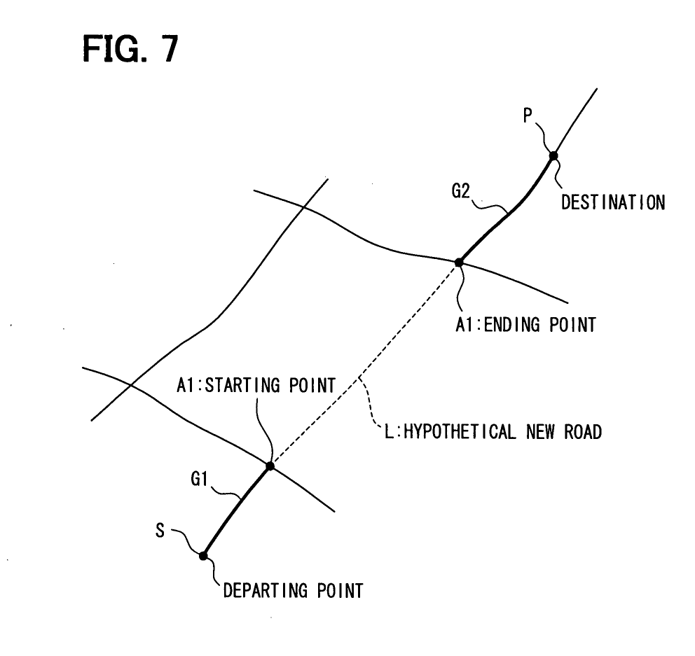

Then, if the destination is inputted, the process proceeds to step D5, where a driver is asked whether he/she wants to register a new road which is not included in the stored map data. If the registration of a new road is desired, the process proceeds to step D6. At step D6, a starting point A1 (refer to FIG. 7) of a new road or a line showing a new road is inputted by the driver through the touch panel 7. If the driver does not want the registration of a new road, the process proceeds from step D5 to step D13, where a usual route guidance is given to the driver.

If the starting point A1 of the new road is inputted at step D6, the process proceeds to step D7, where the driver is required to input an ending point A2 of the new road. After the starting point A1 and the ending point A2 are inputted, the process proceeds to step D8. At step D8, the controller 2 calculates positions of two points that are closest to the starting point A1 and an ending point A2 and are positioned on the stored map data. Then, at step D9, a line connecting the calculated two points is shown on the display panel 5 as a hypothetical new road L. If the driver inputs a line connecting a starting point and an ending point of a new road at step D6, the process proceeds to step D10, where two points positioned on the stored map data and closest to the starting point and the ending point of the inputted line are calculated. Then, at step D11, the line inputted by the driver is shown on the display panel 5 as the hypothetical new road L.

The steps described above are further explained with reference to a schematic map shown in FIG. 7. After the departing point S and the destination P on the stored map data are set, the driver inputs either a pair of starting point A1 and ending point A2 of a new road (which are newly built and not included in the stored map data) or a line connecting two points A1 and A2. Based on the inputted two points or the inputted line, a hypothetical new road L is shown on the display panel 5. Then, at step D12, the controller 2 searches a driving route including the hypothetical new road L from the departing point S to the destination P. This means that the driving route includes old roads G1 and G2 stored in the map data and a hypothetical new road L which is not included in the stored map data.

In searching a driving route having a shortest distance from the departing point S to the destination P, a distance of the hypothetical new road L is assumed to be zero. By making this assumption, it is highly possible that the hypothetical new road L is included in the driving route. After the driving route is determined, the driving route is displayed on the display panel in a highlighted manner at step D14.

Then, at step D15, a route guidance is given to the driver in a usual manner along the driving route shown on the display panel 5. When the vehicle arrives at the starting point A1 of the new road at step D16, the controller 2 switches the operation mode to an off-road mode because the vehicle enters into a route which is not included in the stored map data. No route guidance is given to the driver under the off-road mode. In other words, the driver drives the vehicle without the route guidance from point A1 to the point A2. When the vehicle arrives at the ending point A2 of the new road at step D18, an actually driven locus is registered as a new road in the flash memory 13 at step D19. Then, at step D20, the operating mode is switched to the usual route guidance mode, and the driver is guided to the destination P. When it is determined that the vehicle has arrived at the destination P at step D21, the process comes to the end (RETURN).

In the second embodiment described above, a new road that is not included in the stored map data is registered according to instructions of a driver (or a user). Therefore, Registration of a parking space or a small private road, which is not desired to be registered, is surely avoided.

The present invention is not limited to the embodiments described above, but it may be variously modified. For example, the registration of the driven locus may be made only for a section covering the hypothetical line L. The registration may be made directly in the flash memory 13. Memory media for the registering the new road is not limited to the flash memory 13, but the registration may be made in the memory device 4 for storing map data. The question to a driver as to whether he/she recognizes that he/she has been driving on a new road not stored in the map data may be shown on the display panel 5, and the driver's reply may be made by touching the touch panel 7.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A navigation device for use in an automotive vehicle, the navigation device having a display panel on which a road map read out from stored map data and a present position of the vehicle are displayed, the navigation device comprising:
a speed detector for detecting a driving speed of the vehicle;
means for determining whether a road on which the vehicle is driving is included in the stored map data;
speed-change detecting means for detecting whether a driving speed of the vehicle changed when the vehicle entered onto a new road which is not included in the stored map data from an old road included in the stored map data;
means for memorizing a driven locus of the vehicle for a period in which the vehicle is driven on the new road if the vehicle speed did not change when the vehicle entered onto the new road; and
means for registering the driven locus of the vehicle as a new road in the stored map data.

2. The navigation device as in claim 1, wherein: the navigation device further includes means for asking a driver a question as to whether the vehicle has been driven on a newly build road when the vehicle returns onto the old road from the new road, and means for inputting a reply of the driver to the navigation device; and
the registering means registers the driven locus as a new road only when the question to the driver is affirmed.

3. A navigation device for use in an automotive vehicle, the navigation device having a display panel on which a road map read out from stored map data and a present position of the vehicle are displayed, the navigation device comprising:
means for determining whether the present position of the vehicle is on an old road which is included in the stored map data;
means for inputting to the navigation device at least both ends of a new road which is not included in the stored map data, the both ends of the new road being connected to the old road;
means for memorizing a driven locus of the vehicle during a period in which the vehicle is driven on the new road; and
means for registering the driven locus of the vehicle as a new road in the stored map data.

4. The navigation device as in claim 1, wherein the speed change-detecting means determines that the driving speed of the vehicle changed if an amount of the speed change is higher than a predetermined amount.
